(19) United States
(12) Patent Application Publication
(10) Pub. No.: US 2007/0065090 A1
(43) Pub. Date: Mar. 22, 2007

(54) ELECTRONIC DEVICE HAVING A ROTATING HOUSING

(76) Inventor: Yung-Kun Lin, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(21) Appl. No.: 11/423,135

(22) Filed: Jun. 8, 2006

(30) Foreign Application Priority Data
Sep. 16, 2005 (TW) 094132144

(51) Int. Cl. G02B 6/00

(52) U.S. Cl. 385/147

(57) ABSTRACT

An electronic device having an enclosure capable of being rotated horizontally and displaced vertically, the electronic device includes a first housing, a second housing and a sleeve module. The sleeve module is coupled to the first housing and the second housing. The first housing is shifted vertically relative to the second housing according to the rotation of the sleeve module.

### BACKGROUND OF THE INVENTION

1. Field of the Invention

This invention relates to an electronic device, and more particularly, to an electronic device having a rotating housing.

2. Description of the Prior Art

In our modern society with advanced information systems, the convenience of portable electronic devices continue to be applied to our everyday lives. People exchange information, ideas and personal experiences through the use of portable electronic devices. Electronic products are constantly improved according to continual advancements in technology. In accordance with consumer needs, it is critical that electronic products not only appear functional, but are also easily accessible.

Many currently marketed handheld electronic devices (e.g. cell phones or personal digital assistants) adopt a rotary opening or closing lid design in their enclosure. The key to this design is the utilization of two portions for the enclosure, an upper housing and a lower housing, both of which constitute the entire enclosure. These pieces are connected through an additional axle hinge and hinge fixed module structure that allows for an opening or closing action to occur. In particular, when a conventional electrical device opens in a rotary fashion, the upper housing usually covers a significant portion of lower housing, thus reducing the usable area of the lower housing. This can include space for various user command input components (e.g. keypads for a cellular phone), or other relevant device components. The reduced area of the lower housing may also cause further inconveniences in usage and development, including reduced flexibility in ergonomic design, and the potential limitation of particular features. In spite of this, electronic devices today continue to apply the axle hinge to allow for an opening and closing action of an electronic device enclosure. The structure of the axle hinge, however, can be fairly complicated and uncompromising, and can make it difficult to integrate various electronic components into the housing. These difficulties not only pose problems in design, but can create issues in large scale production, resulting in increased production costs.

### SUMMARY OF THE INVENTION

It is therefore an objective of the claimed invention to provide an electronic device having a rotating housing, the housing capable of being rotated horizontally while simultaneously being shifted along the vertical direction. This housing will not only help meet the aesthetic demands consumers may have for various devices, but also provide a more practical and ergonomic solution to the aforementioned problems.

According to an aspect of the present invention, an electronic device is disclosed. The electric device includes a first housing, a second housing, and a sleeve module. The sleeve module is coupled to the first housing and the second housing, wherein the first housing is rotated relatively to the second housing by means of the sleeve module.

According to another aspect of the present invention, an electronic device is disclosed. The electric device includes a first housing, a second housing, and a sleeve module. The sleeve module is coupled to the first housing and the second housing, wherein the first housing is rotated relatively to the second housing and moved up or down vertically by means of the sleeve module.

When the housing of electronic device described by the present invention is opened, the useable area on the second housing will not be inadvertently covered through rotation of the first housing. A designer utilizing this case can therefore implement additional components into each housing without space limitations that would otherwise be inherent in previous designs. Therefore, the electronic device of the present invention improves the space deficiency problem that would otherwise exist in an enclosure of this nature. This allows for a conventional user command input module or operation interface to be implemented without drastic redesign of these components. Moreover, since the conventional axle hinge structure in a conventional electronic device enclosure is replaced by the sleeve module of this present invention, the rotating apparatus portion becomes simplified. The overall usability is improved and large-scale manufacturing costs become reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the external view of the electronic device described in the present invention.

FIG. 2 is a diagram illustrating the component assembly and composition diagram of the electronic device described n in FIG. 1.

FIG. 3 is a diagram illustrating the sleeve module of the present invention.

FIG. 4 is a diagram illustrating an external view of the electronic device opened to 90 degrees according to the present invention.

FIG. 5 is a diagram illustrating an external view of the electronic device opened to 180 degrees according to the present invention.

FIG. 6 is a diagram illustrating an external view of the electronic device opened to 270 degrees according to the present invention.

FIG. 7 is an expanded cross-sectional view of the sleeve module shown in FIG. 3.

FIG. 8 is a cross-sectional view of the sleeve module opened to 90 degrees.

FIG. 9 is a cross-sectional view of the sleeve module opened to 180 degrees.

FIG. 10 is a cross-sectional view of the sleeve module opened to 270 degrees.

### DETAILED DESCRIPTION

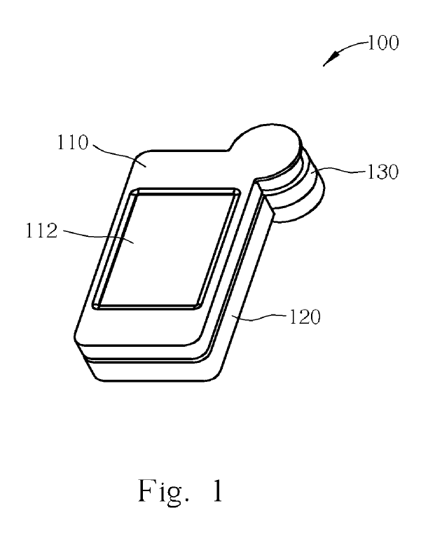

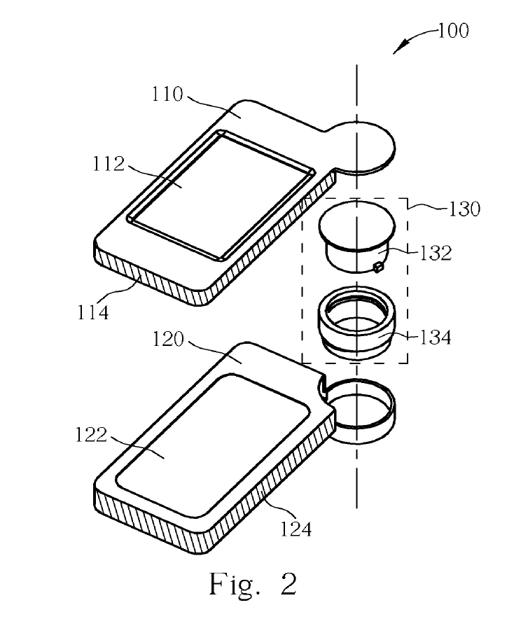

FIG. 1 is an enlarged view illustrating the exterior of the electronic device 100 described in the present invention. FIG. 2 is an assembly diagram of the electronic device 100 illustrating each component and their relative placement to each other. For the preferred embodiment, the electronic device 100 is perceived as a portable electronic device, such as a cell phone or a personal digital assistant (PDA).

As shown in FIG. 1, the electronic device 100 includes a first housing 110, a second housing 120 and a sleeve module 130. As shown in FIG. 2, the first housing 110 includes a display monitor 112 placed in the first housing 110 for visually displaying a user interface for the electronic device 100. The second housing 120 includes a main control circuit (not shown) of the electronic device 100 for controlling or processing the operation of the electronic device 100. A user command input module 122 is located on the second housing 120 for inputting user commands to the main control circuit. For the preferred embodiment, please note that the display monitor 112 constitutes the main display monitor of the electronic device 100. However, other display components may also be incorporated into the electronic device 100. For example, according to different design requirements, an alternate display module (not shown) can be set up inside the second housing 120. Additionally, the first housing 110 and the second housing 120 each individually have a side 114 and side 124 (shown as the oblique line in FIG. 2) respectively. Side 114 surrounds four sides of the first housing 110, while side 124 surrounds four sides of the second housing 120. The sleeve module 130 is coupled between the first housing 110 and the second housing 120 along side 114 and side 124. Through rotation of the sleeve module 130, the first housing 110 is capable of being shifted up and down, while experiencing rotation relative to the second housing 120. Please note that in this preferred embodiment, the sleeve module 130 is located on the upper right corner of the first and the second housing. Alternate embodiments may have the sleeve module 130 located on any position along side 114 and side 124 to connect the first housing 110 to the second housing 120 while achieving the same design. The placement of the sleeve module 130 does not limit the scope of this invention in any way, and therefore any arbitrary placement and configuration as such would still belong to the present invention therein.

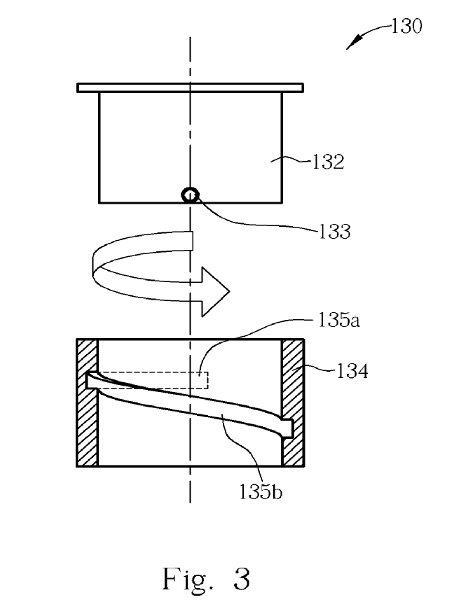

FIG. 3 is a diagram illustrating the exterior of the sleeve module 130 according the present invention. As shown in FIG. 3, the sleeve module 130 includes a sleeve 132 coupled to the sleeve base 134. The sleeve base 134 is coupled to the first housing 110, while the sleeve 132 includes a guide pillar 133. The sleeve base 134 also includes a spiral slit 135, while being further coupled to the second housing 120. For the preferred embodiment, the spiral slit 135 includes a horizontal track 135a and a sloped track 135b, wherein the guide pillar 133 is lodged in the cavity of the spiral slit 135. Thereby, when the first housing 110 is rotated relative to the second housing 120, the guide pillar 133 slides along the spiral slit 135 to control the rotational and vertical movement of the first housing 110. Alternatively, please note that the guide pillar 133 may also be located on the sleeve base 134, with the spiral slit 135 located on the sleeve 132. Also, the sleeve 132 may be located on the first housing 110, while the sleeve 134 is located on the second housing 120. Many possible variations can be configured to rotate the first housing 110 relative to the second housing 120, and as such, configurations obtaining the same objective also belong to the claimed invention. Further detail describing the vertical-rotational movement of first housing 110 relative to the second housing 120 thorough a sleeve module 130 according to the present invention are described below.

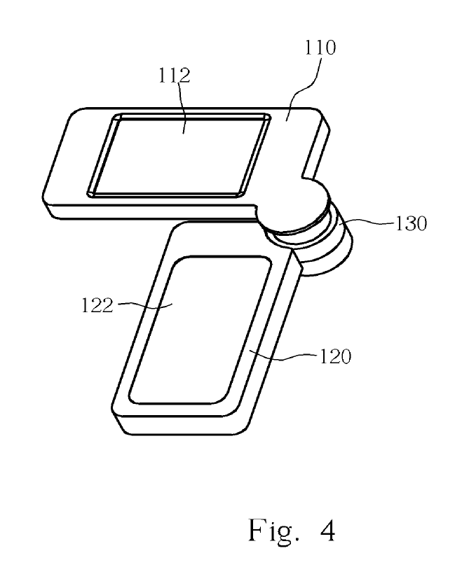

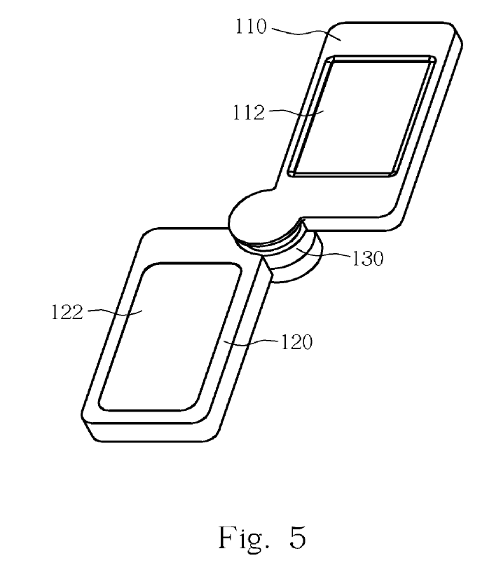

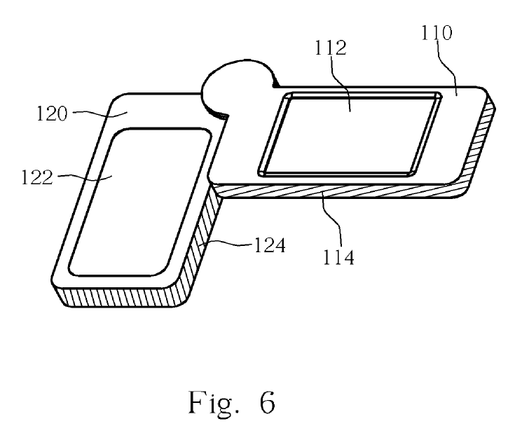

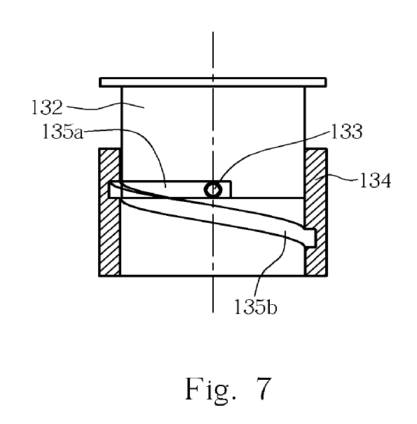

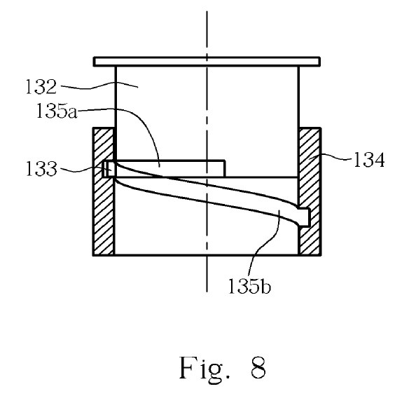

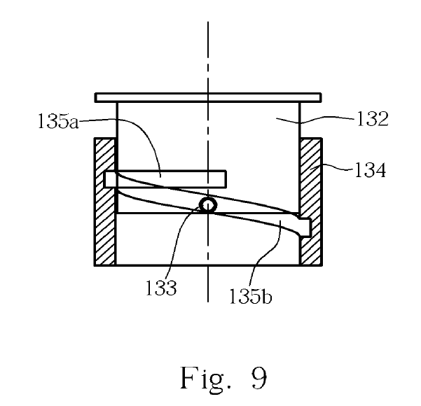

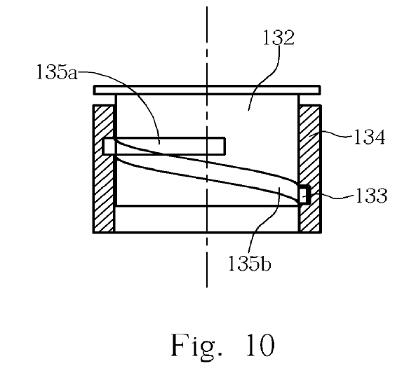

Description of this section regarding the movement of first housing 110 relative to the second housing 120 will draw referral from figures form FIG. 4 to FIG. 10. FIG. 4 is an external diagram of the electronic device 100 of the present invention, with the enclosure opened at 90 degrees. FIG. 5 is the external diagram of the electronic device 100 of the present invention with the enclosure opened at 180 degrees. FIG. 6 is the external diagram of the electronic device 100 of the present invention with the enclosure opened at 270 degrees. FIG. 7 is a cross sectional close-up view of the sleeve module 130, as also shown in FIG. 3. FIG. 8 is a cross sectional view of the sleeve module 130, while the enclosure is opened at 90 degrees. FIG. 9 is a cross sectional view of the sleeve module 130, while the enclosure is opened at 180 degrees. FIG. 10 is the cross section view of the sleeve module 130, while the enclosure opened at 270 degrees.

FIG. 7 shows the start of the full sequence of movements, with the guide pillar 133 of the sleeve 132 being located in the front of the horizontal track 135a of the spiral slit 135. From there on, the guide pillar 133 is moved along the spiral slit 135 by means of rotating the first housing 110 relative to the second housing 120. After the first housing 110 has been rotated to 90 degrees relative to the second housing, the guide pillar 133 of the sleeve 132 is positioned at the end of the horizontal track 135a of the spiral slit 135 (FIGS. 4,8). This first stage of movement from the closed position to 90 degrees solely involves rotational displacement. However, subsequent stages of movement not only involve rotational displacement, but also incorporate vertical displacement. After the first housing 110 has been rotated relative to the second housing 120 by 90 degrees, the first housing 110 also begins descending vertically relative to the second housing 120. This is accomplished through sliding the guide pillar 133 along the sloped track 135b in the spiral slit 135. FIGS. 5 and 9 illustrate the second stage of movement. The guide pillar 133 of the sleeve 132 begins moving to the midpoint of the sloped track 135b by means of the rotating the first housing 110. This results in the first housing 110 being rotated relative to the second housing 120 by 180 degrees. The third stage in the sequence of movements is illustrated through FIG. 6 and FIG. 10. These figures show the first housing 110 rotated relative to the second housing 120 at 270 degrees. The guide pillar 133 of the sleeve 132 is moved to the end of the sloped track 135b of the spiral slit 135 through the rotation of the first housing 110.

After the first housing 110 has been rotated relative to the second housing 120 to 270 degrees, the side 114 of the first housing 110 begins to touch the side 124 of the second housing 120. This position thus prevents any further rotation in the same direction. In this preferred embodiment, please note that movement of the first housing 110 relative to the second housing 120 is done in specific increments, or specific rotating angles and configurations. Other embodiments, however, may have the first housing 110 designed to move relative to the second housing 120 in increments according to another predetermined rotational angle or configuration without violating the scope of the present invention. For example, the sloped track 135b of the spiral slit 135 can be changed to rising track instead, with the first housing 110 being moved along the rising track by applying the same principles of the present invention.

Additionally as shown through FIGS. 4 to. 6, when the enclosure of the electronic device 100 has been opened, the user command input interface 122 within the second housing 120 will not be inadvertently covered through the rotation of the first housing. This allows a designer utilizing this enclosure to fully utilize the second housing without unnecessary limitations to the location and size of the user command input module 122. As described above, the electronic device of the present invention solves the problem of space deficiency and limitation caused through the movement of a rotating enclosure. Furthermore, by replacing the conventional axle hinge structure in a conventional electrical device with the sleeve module 130 of the present invention, the electronic device 100 with a rotating enclosure is simplified. This helps alleviate many problems that would be otherwise present in design, and reduces production costs in large-scale manufacturing.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, comprising:
a first housing;
a second housing; and
a sleeve module coupled to the first housing and the second housing, wherein the first housing is horizontally rotated and vertically displaced relative to the second housing by means of the sleeve module.

2. The electronic device of claim 1, wherein the sleeve module is coupled to a side of the first housing and a side of the second housing, and the first housing is rotated on a horizontal plane relative to the second housing by means of the sleeve module.

3. The electronic device of claim 1, wherein the sleeve module comprises:
a sleeve coupled to the first housing, the sleeve comprising a guide pillar; and
a sleeve base coupled to the second housing, wherein the sleeve base comprises a spiral slit, and the guide pillar is lodged into the spiral slit such that the guide pillar is moved along the spiral slit to control the vertical movement of the first housing during rotation.

4. The electronic device of claim 3, wherein the spiral slit comprises a horizontal track and a sloped track, the guide pillar being moved along the horizontal track when the first housing is rotated relative to the second housing through the sleeve module rotating towards a first predetermined angle, and the guide pillar being moved along the sloped track when the first housing is rotated relative to the second housing by means of the sleeve module upon rotation past the first predetermined angle.

5. The electronic device of claim 3, wherein when the first housing is rotated relative to the second housing towards a second predetermined angle, the second predetermined angle being greater than the first predetermined angle, the guide pillar is moved along the sloped track, and the side of the first housing will contact the side of the second housing.

6. The electronic device of claim 1, wherein the sleeve module comprises:
a sleeve base coupled to the second housing, the sleeve base comprising a guide pillar; and
a sleeve coupled to the first housing, wherein the sleeve comprises a spiral slit and the guide pillar is lodged within the spiral slit, the guide pillar moving along the spiral slit to control the vertical movement of the first housing during rotation of the first housing.

7. The electronic device of claim 6, wherein the spiral slit comprises a horizontal track and a sloped track, and the guide pillar moves along the horizontal track when the first housing is rotated relative to the second housing by means of the sleeve module towards a first predetermined angle, and the guide pillar is moved along the sloped track when the first housing is rotated relative to the second housing by means of the sleeve module after rotating past the first predetermined angle.

8. The electronic device of claim 7, wherein the guide pillar moves along the sloped track and the side of the first housing comes in contact with the side of the second housing when the first housing is rotated relative to the second housing towards a second predetermined angle, the second predetermined angling being greater than the first predetermined angle.

9. The electronic device of claim 1 further comprising:
a display monitor set within the first housing; and
a user command input module set within the second housing.

10. The electronic device of claim 1, wherein the electronic device is a portable electronic device.

11. The electronic device of claim 10, wherein the portable electronic device is a cellular phone.

12. An electronic device, comprising:
a first housing;
a second housing; and
a sleeve module coupled to a side of the first housing and a side of the second housing, wherein the first housing is rotated horizontally relative to the second housing by means of the sleeve module.

13. The electronic device of claim 12, wherein the sleeve module comprises:
a sleeve coupled to the first housing, the sleeve comprising a guide pillar; and
a sleeve base coupled to the second housing, wherein the sleeve base comprises a spiral slit, and the guide pillar is lodged within the spiral slit, and the guide pillar being moved along the spiral slit to control the vertical movement of the first housing during rotation.

14. The electronic device of claim 13, wherein the spiral slit comprises a horizontal track and a sloped track, the guide pillar being moved along the horizontal track when the first housing is rotated relative to the second housing through the sleeve module rotating towards a first predetermined angle, the guide pillar being moved along the sloped track when the first housing is rotated relative to the second housing through the sleeve module after rotating past the first predetermined angle.

15. The electronic device of claim 13, wherein the guide pillar moves along the sloped track, and the side of the first housing comes in contact with the side of the second housing when the first housing is rotated relative to the second housing towards a second predetermined angle, the second predetermined angle being greater than the first predetermined angle.

16. The electronic device of claim 12, wherein the sleeve module comprises:
a sleeve base coupled to the second housing, the sleeve base comprising a guide pillar; and
a sleeve coupled to the first housing, wherein the sleeve comprises a spiral slit, and the guide pillar is lodged within the spiral slit, the guide pillar being moved along the spiral slit to control the vertical movement of the first housing during rotation.

17. The electronic device of claim 16, wherein the spiral slit comprises a horizontal track and a sloped track, the guide pillar moves along the horizontal track when the first housing is rotated relative to the second housing through the sleeve module rotating towards a first predetermined angle, and the guide pillar moves along the sloped track when the first housing is rotated relative to the second housing through the sleeve module after rotating past the first predetermined angle.

18. The electronic device of claim 17, wherein the guide pillar moves along the sloped track and the side of the first housing comes in contact with the side of the second housing when the first housing is rotated relative to the second housing towards a second predetermined angle, the second predetermined angle being greater than the first predetermined angle.

19. The electronic device of claim 1 further comprising:
a display monitor set within the first housing; and
a user command input module set within the second housing.

20. The electronic device of claim 12, wherein the electronic device is a portable electronic device.

21. The electronic device of claim 20, wherein the portable electronic device is a cellular phone.
